(19) United States
(12) Patent Application Publication
(10) Pub. No.: US 2014/0335345 A1
(43) Pub. Date: Nov. 13, 2014

(54) CORROSION-RESISTANT SCREW, USE OF A SCREW OF THIS TYPE IN A CORROSIVE ENVIRONMENT, AND METHOD FOR THE FABRICATION OF A SCREW OF THIS TYPE

(71) Applicant: Baier & Michels GmbH & Co. KG, Ober-Ramstadt (DE)

(72) Inventor: Olaf Ambros, Biblis (DE)

(73) Assignee: Baier & Michels GmbH & Co. KG, Ober-Ramstadt (DE)

(21) Appl. No.: 14/362,570

(22) PCT Filed: Dec. 4, 2012
(86) PCT No.: PCT/EP2012/074311

§ 371 Date: Jun. 3, 2014

(30) Foreign Application Priority Data
Dec. 4, 2011 (DE) 102011087683.9

(51) Int. Cl. F16B 25/00; B32B 7/08; F16B 35/04; B21K 1/56

(52) U.S. Cl. CPC F16B 25/00; B21K 1/56; B32B 7/08; F16B 35/04
USPC 428/223; 470/9; 411/424

(57) ABSTRACT

The invention relates to a screw, having a shank which is provided with a thread, produced from a material which is suitable for a strength-increasing thermal treatment and is resistant to corrosion, and to the use of a screw of this type in a corrosive environment in conjunction with a corrosion-resistant component to be screwed, and, furthermore, to a method for producing a screw of this type. Screws of this type are used, in particular, for direct screwing.

### BACKGROUND OF THE INVENTION

The invention relates to a screw having a screw-threaded shank that is made of a material suitable for strength-increasing thermal treatment and that is resistant to corrosion, and to the use of a screw of this type in a corrosive environment in conjunction with a non-corroding component to be screwed, and, furthermore, to a method for fabricating a screw of this type.

Such screws are used, in particular, for what is called direct assembly joints in which the screw itself forms a thread in a female component which usually has a corresponding through hole or blind hole for accommodation of the screw.

### PRIOR ART

In the prior art, it is known to use screws made of a non-corroding material, such as stainless steel, in a corrosive environment, as in DE 297 06 372 U1, for example. However, the strength of such screws is insufficient for some applications. For example, greater strength is required in direct assembly joints in plastics materials or in carbon fiber composite materials.

EP 0 948 719 B1 discloses a screw to be driven into plastics material which, on account of its geometry, can be composed of a material which displays less strength than the conventionally employed materials for screws to be driven into a plastics material.

DE 198 15 670 A1 discloses a corrosion-resistant thread-forming screw with partially cured portions having reduced corrosion resistance, which portions account for only a small region of the screw required to bore a hole and form a thread, whilst no curing takes place in the supporting region of the screw.

Basically, titanium screws would be suitable, but the cost of the production of such screws on a large scale would be too high.

The German Standard DIN EN 10269 “Steels and nickel alloys for fasteners for use at elevated and/or low temperatures” lists the requirements placed on materials for fastening elements made of non-alloyed and alloyed (including stainless) steels and nickel alloys.

Screws produced from these materials are suitable for a strength-increasing thermal treatment, and are resistant to corrosion.

### SUMMARY OF THE INVENTION

In a first aspect, the invention relates to a screw comprising a screw-threaded shank consisting of a material which is suitable for a strength-increasing thermal treatment and which is resistant to corrosion. The screw has a predetermined initial strength prior to the formation of the thread by reshaping, which initial strength results from heat treatment. For the purpose of producing the thread, the shank is shaped with thread profiles, thread flanks, and a thread root, and the thread profiles thus have increased initial strength over that of the unshaped region on account of the resulting strain hardening, and have a second strength. Furthermore, the thread is thread-forming or self-tapping.

Such a screw displays adequate strength, on the one hand, and adequate resistance to corrosion on the other.

Advantageously, the material of which the screw is made can be resistant, in particular, to galvanic corrosion due to contact with carbon or carbon fiber reinforced composite material. Since it is inadvisable to place carbon, on account of its electrochemical potential, near steel, it is particularly important for continuous use of the screw that this sort of corrosion be avoided, regardless of whether the environment is corrosive or not.

Advantageously the screw can be made of a high temperature material in accordance with EN 10269 or similar, particularly of an austenitic material or a nickel-base alloy.

A particular embodiment relates to a screw in which the pitch (P), based on the external diameter (Da) shows a ratio Q1=P/Da of from 0.3 to 0.385 where each turn of thread in the thread root between the thread flanks has a radius Rg and the radius (Rg) based on the pitch shows a ratio Q2=Rg/P of from 0.5 to 1.0, preferably from 0.6 to 0.8. It has been found that such a screw is suitable for use in plastics components, more particularly in thermoplastics and thermosets having a high fiber content.

Advantageously, the transition of the thread root with a radius of Rg to the thread flank can range from 25° to 45°, more particularly from 28° to 38° and the flank angle can lie in an angular range of from 20° to 30°. It has been shown that at these angles the thread flanks have adequate stability when penetrating the female component.

Advantageously, the shank can comprise thread tips formed by reshaping and a non-reshaped region in the thread core, and the thread tips can be formed with a second strength that is higher than that of the non-reshaped region showing the first strength, the second strength of the thread tips achieved by reshaping being greater than the first strength by at least 10%, preferably by 30% to not more than 55%.

Advantageously, the screw displays a metric, self-tapping thread and can be composed of a material which is resistant to galvanic corrosion caused by contact with non-rusting stainless steel.

In another aspect, the invention relates to the use of the screw of the invention in a corrosive environment in conjunction with a screwed component which is resistant to corrosion in this environment.

In yet another aspect, the invention relates to a method for fabricating a screw of the generic type and consisting of a material suitable for a strength-increasing thermal treatment, wherein, starting from a thermally treated blank to increase the strength thereof, reshaping of the blank to produce he screw geometry takes place following the thermal treatment on the blank. Any further treatment to substantially change the strength is not envisaged.

Advantageously, pickling may be carried out to remove particles that are not corrosion resistant and that result from reshaping of the screw strengthened by thermal treatment. For example, such particles can be transferred from the dies to the screw. The process of pickling, which removes a thin metallic layer, avoids tramp iron corrosion.

Advantageously, in order to form a passive protective layer on the surface, so-called passivation can be applied. In the passivation treatment no material is removed but the properties and the thickness of the passive layer are optimized selectively.

In another aspect, the invention relates to a construction unit comprising a plurality of components including at least two components made of different materials, the components being provided with a hole of a diameter depending on the respective material for accommodation of the screw for the purpose of creating the screw connection. The material of one of the components is a carbon fiber composite material and the material of the other component is a non-ferrous casting, more particularly one having a hard casting skin, a composite material such as a fiber composite material, a compact composite material such as a glass bead composite material or a hybrid form thereof, wherein the at least two components composed of different materials are joined together by means of one or more identical screws of the invention to form a construction unit.

Hitherto no such assembly groups have been manufactured in large-scale production for lack, inter alia, of inexpensive screws.

### BRIEF DESCRIPTION OF THE DRAWINGS

The method of the invention is explained below with reference to the drawings, in which:

FIG. 1 is a side view of a screw of the invention for screwing into plastics material;

FIG. 2 is a detail illustrating the process of shaping the screw shown in FIG. 1;

FIG. 3 is a side view of a screw of the invention having metric thread-forming threads;

FIG. 4 shows a construction unit of a plurality of components made of different materials and joined together by means of the screw of the invention.

### EMBODIMENT(S) OF THE INVENTION

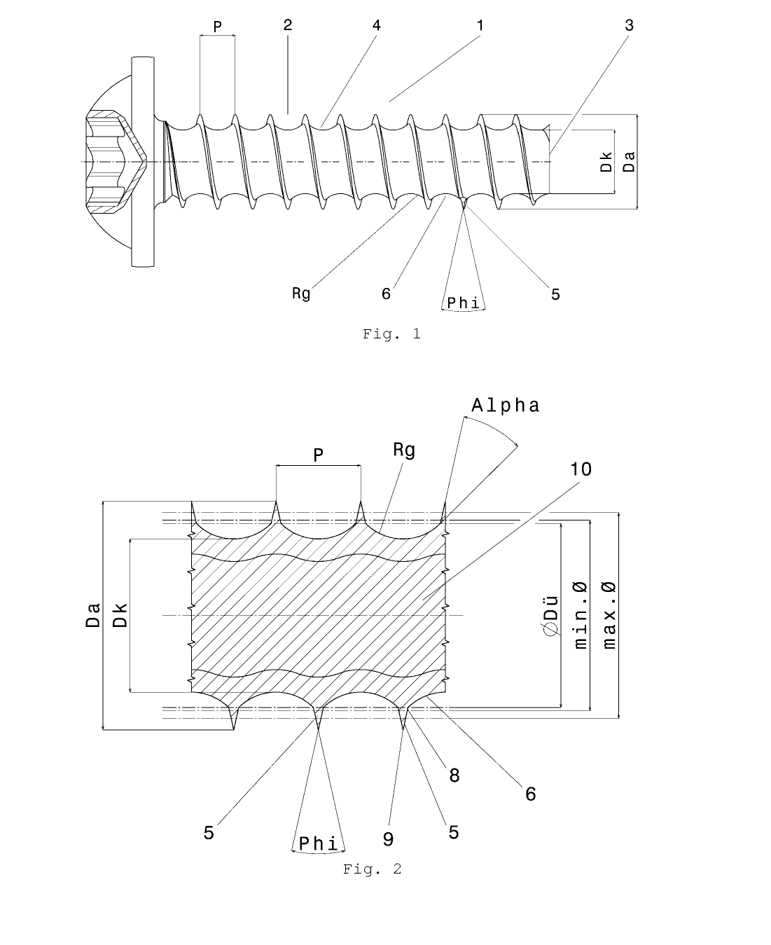

The screw 1 of the invention shown in side view in FIG. 1 for screwing into plastics material and comprising a shank 3 having a thread 2 of external diameter Da and core diameter Dk, the shank 3 being made of a non-corroding material suitable for strength-increasing thermal treatment. Also shown, but irrelevant to this invention, is a head of the screw displaying internal force application surfaces.

The screw has a first strength as predetermined by the thermal treatment carried out prior to the formation of the thread 2 by reshaping, while the shank 3 has additionally been reshaped in order to produce the thread 2 with its turns 4, flanks 5 having a flank angle of phi and a thread root 6.

The turns 4 and, in particular, the thread flanks 5 have increased strength as compared with the strength of the non-reshaped region 7 of the screw 1, on account of the strain hardening caused by reshaping, for example inside the shank 3, the screw 2 being thread forming or self-tapping.

FIG. 2 is a detail showing the shape of the screw thread shown in FIG. 1. In such a screw, the thread pitch P in relation to the external diameter Da has a ratio of Q1=P/Da of from 0.3 to 0.385 and in the present case a ratio of 0.37. Each turn 3 has in the thread root 6 between the thread flanks 5 a radius Rg, which radius Rg, in relation to the thread pitch P, has a ratio Q2=Rg/P of from 0.5 to 1.0, preferably from 0.55 to 0.8 and in the present case a ratio of 0.62.

The flank angle phi of the thread flank 5 can be in an angular range of from 20° to 30°, while in the present case the angle phi is 25°.

From the detailed drawing it is also apparent that the curvature at the transition 8 having a diameter Du from the screw root 6 having a radius Rg to the thread flank 5 has an angle alpha ranging from 25° to 45°, more particularly from 28° to 38°, while in this particular case it is approximately 32°.

The two other diameters min. and max. are of no significance with regard to the description of the invention.

The shank 3, already possessing a first strength prior to reshaping in order to produce the thread 2 having thread tips 9, has a non-reshaped core region 10 with the result that the thread tips 9 have greater strength than the non-reshaped core 10, wherein the strength achieved by reshaping being at least 10%, preferably 30% and at most 55% higher.

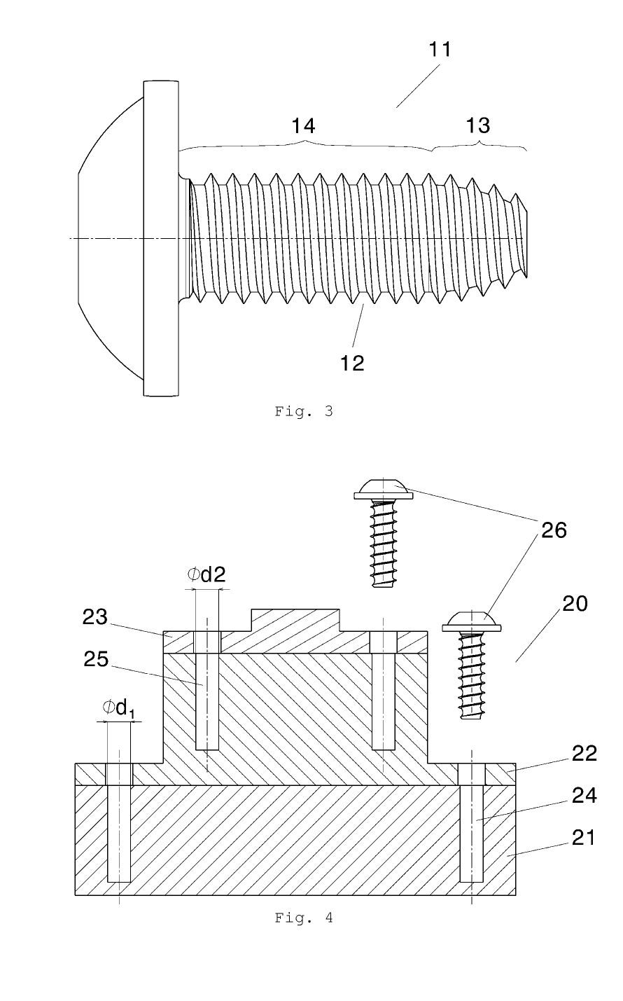

FIG. 3 is a side view of another screw of the invention 11 having a metric thread-forming thread 12. The thread 12 has an increasing diameter in the tapping region 13 which merges into the load-bearing thread portion 14. In both regions 13 and 14 the thread turns are fully formed with the result that the core diameter increases from the tip to the load-bearing region 14.

The screws 1, 11 can be used in a corrosive environment in conjunction with a component which is resistant to corrosion in said environment.

FIG. 4 shows an structural unit 20 consisting of a plurality of elements 21, 22, 23 made of various materials, the components 21 and 22 each having at least one hole, in this case a blind hole 24 and of an appropriate hole diameter d1, d2, depending on the material, for accommodation of the screw 26 for the purpose of creating the screwed connection. The component 21 may be made of a carbon composite material and component 22 can be made of a non-ferrous casting, more particularly one having a hard casting skin, or a fiber reinforced composite material, a compact composite material such as a glass bead composite, and hybrids hereof. The components 21 to 23 are joined to the single structural unit 20 by means of one or more identical screws 26.

When producing the thread by reshaping, attention should be paid to the fact that the temperature occurring during the entire reshaping process must be lower than the temperature that would eliminate the strength resulting from the thermal treatment. This can be achieved by producing the screw geometry by means of rolling involving a sufficiently large reshaping length of the rolling tool.

Materials suitable for the application of the screw can include: an Al die casting, an Al/Mg die casting, an Mg die casting, a carbon fiber reinforced plastics material, or a fiber glass reinforced plastics material, such as an unsaturated polyester.

The screw can be made of an austenitic corrosion-resistant steel alloy of high strength and is suitable for use in cast or bored core holes without the occurrence of galvanic corrosion in contact with the material into which it is screwed.
Please find a listing of the claims below, with the statuses of the claims shown in parentheses. This listing will replace all prior versions, and listings, of claims in the present application.

1. A screw comprising:
a shank including a thread and formed of a material that is suitable for a strength-increasing thermal treatment and resistant to corrosion, wherein the screw has a first strength predetermined by thermal treatment carried out prior to creation of the thread by reshaping, wherein the shank is reshaped in order to produce the thread including turns, flanks, and a thread root, and the thread turns include, on account of strain hardening caused by reshaping, an increased strength compared to a strength of a non-reshaped region, and wherein the screw further includes a second strength, the thread being at least one of thread-forming and self-tapping.

2. The screw according to claim 1, wherein the material is resistant to galvanic corrosion due to contact with at least one of carbon and carbon fiber reinforced composite materials.

3. The screw according to claim 1, wherein the screw is made of a high-temperature material in accordance with European steel and alloy grades EN 10269.

4. The screw according to claim 1, wherein a pitch (P), based on an external diameter (Da) includes a ratio Q1=P/Da of approximately 0.3 to 0.385 where each turn of the thread in the thread root between the thread flanks includes a radius Rg, and the radius (Rg) based on the pitch includes a ratio Q2=Rg/P of approximately 0.5 to 1.0.

5. The screw according to claim 4, wherein a transition of the thread root to the thread flank ranges from approximately 25° to 45°, and a flank angle includes an angular range of approximately 20° to 30°.

6. The screw according to claim 1, wherein the shank comprises thread tips formed by reshaping and the non-reshaped region in a thread core, and the thread tips are formed with the second strength that is higher than the strength of the non-reshaped region including the first strength, the second strength of the thread tips that is achieved by reshaping being greater than the first strength by at least approximately 10% to approximately 55%.

7. The screw according to claim 1, wherein the screw comprises a metric, thread-forming thread, and includes a material that is resistant to galvanic corrosion when in contact with stainless steel.

8. The use of the screw according to claim 1 in a corrosive environment in conjunction with a component to be screwed that is not corroded by the corrosive environment.

9. A method for the fabrication of a screw according to claim 1, the method comprising:
heat treating a blank for strength enhancement; and
reshaping the blank for production of the screw geometry after the heat treatment of the blank.

10. The method according to claim 9, further comprising:
pickling to remove any non-corrosion-resistant particles that result from reshaping of the screw strengthened by thermal treatment.

11. The method according to claim 9, further comprising:
applying passivation on a screw surface to form a passive protective coating on the surface.

12. A construction unit comprising a plurality of components including at least two components of different materials, wherein the at least two components comprise a hole diameter, dependent on the respective material, for purpose of accommodating the screw according to claim 1 to form a screwed joint, wherein a material of one of the at least two components is a carbon fiber composite material and a material of another one of the at least two components is a non-ferrous casting, wherein the at least two components are joined together by the screw to form the construction unit.

13. The screw according to claim 1, wherein the screw is made of an austenitic material or a nickel-base alloy.

14. The screw according to claim 4, wherein the ratio Q2 is approximately 0.6 to 0.8.

15. The screw according to claim 5, wherein the thread flank ranges from approximately 28° to 38°.

16. The screw according to claim 6, wherein the second strength of the thread tips that is achieved by reshaping is greater than the first strength by approximately 30%.

17. The construction unit according to claim 12, wherein the non-ferrous casting includes a hard casting skin.

18. The construction unit according to claim 12, wherein the material of the another one of the at least two components is a fiber reinforced composite material.

19. The construction unit according to claim 12, wherein the material of the another one of the at least two components is a glass bead composite material.
